(19) United States
(12) Patent Application Publication
(10) Pub. No.: US 2025/0252074 A1
(43) Pub. Date: Aug. 7, 2025

(54) MEMORY MODULE AND COMPUTING SYSTEM INCLUDING THE SAME

(71) Applicant: SAMSUNG ELECTRONICS CO., LTD., Suwon-si (KR)

(72) Inventors: Yongsuk Kwon, Suwon-si (KR); Jungho Ahn, Seoul (KR); Sungmin Yun, Seoul (KR); Kyungsoo Kim, Suwon-si (KR); Jinin So, Suwon-si (KR); Jonggeon Lee, Suwon-si (KR)

(73) Assignee: SEOUL NATIONAL UNIVERSITY R&DB FOUNDATION, Seoul (KR)

(21) Appl. No.: 19/017,235

(22) Filed: Jan. 10, 2025

(30) Foreign Application Priority Data
Feb. 5, 2024 (KR) 10-2024-0017215
May 9, 2024 (KR) 10-2024-0060980

(51) Int. Cl. G06F 13/42

(52) U.S. Cl. CPC G06F 13/4282; G06F 13/4221

(57) ABSTRACT

A memory module includes a substrate, an allocator, memory cluster packages and serial communication lanes. The allocator is mounted on the substrate, and communicates with an external device through a CXL interface. The memory cluster packages are mounted on the substrate, and are controlled by the allocator. Each of the memory cluster packages includes memories and a memory controller. The serial communication lanes are disposed on the substrate for communications between the allocator and the memory cluster packages. A first memory cluster package communicates with the allocator through a first serial communication lane and the serial interface. A second memory cluster package communicates with the first memory cluster package through a second serial communication lane and the serial interface.

### CROSS-REFERENCE TO RELATED APPLICATION

This application claims priority under 35 USC § 119 to Korean Patent Application No. 10-2024-0017215 filed on Feb. 5, 2024, and to Korean Patent Application No. 10-2024-0060980 filed on May 9, 2024, in the Korean Intellectual Property Office (KIPO), the contents of which are herein incorporated by reference in their entirety.

### BACKGROUND

Computing systems may provide various information technology (IT) services to users. As various IT services are provided to the user, the amount of data that are processed by the computing systems increases. For this reason, there is a need to improve a speed at which data are processed. The computing systems are developing into heterogeneous computing environments to provide various IT services. Various technologies for processing data at a high speed within the computing systems and/or the heterogeneous computing environments are being developed.

A computing system may include a host device for processing data based on executed instructions or programs. Due to size and memory constraints, the computing system may include a storage device for storing the instructions (or programs) and data. In this case, the instructions and data are transmitted from the storage device to the host device, and the host device processes the data based on the instructions. However, this communication between the host device and the storage device may serve as a bottleneck for the operating speed of the computing system.

### SUMMARY

Some implementations according to the present disclosure provide memory modules capable of improving or enhancing the effective bandwidth. Some implementations according to the present disclosure provide computing systems including the memory modules.

According to some implementations, a memory module includes a substrate, an allocator, a plurality of memory cluster packages and a plurality of serial communication lanes. The allocator is mounted on the substrate, and communicates with an external device through a compute express link (CXL) interface. The plurality of memory cluster packages are mounted on the substrate, and are controlled by the allocator. Each of the plurality of memory cluster packages includes memories and a memory controller. The plurality of memory cluster packages include a first memory cluster package and a second memory cluster package. The plurality of serial communication lanes are disposed on the substrate for communications between the allocator and the plurality of memory cluster packages. The plurality of serial communication lanes include a first serial communication lane between the allocator and the first memory cluster package and a second serial communication lanes between the first memory cluster package and the second memory cluster package. The first memory cluster package communicates with the allocator through the first serial communication lane and the serial interface. The second memory cluster package communicates with the first memory cluster package through the second serial communication lane and the serial interface.

According to some implementations, a computing system includes a host device and a plurality of memory modules. The plurality of memory modules communicate with the host device through a compute express link (CXL) interface. Each of the plurality of memory modules includes a substrate, an allocator, a plurality of memory cluster packages and a plurality of serial communication lanes. The allocator is mounted on the substrate, and communicates with the host device through the CXL interface. The plurality of memory cluster packages are mounted on the substrate, and are controlled by the allocator. Each of the plurality of memory cluster packages includes memories and a memory controller. The plurality of memory cluster packages include a first memory cluster package and a second memory cluster package. The plurality of serial communication lanes are disposed on the substrate for communications between the allocator and the plurality of memory cluster packages. The plurality of serial communication lanes include a first serial communication lane between the allocator and the first memory cluster package and a second serial communication lanes between the first memory cluster package and the second memory cluster package. The first memory cluster package communicates with the allocator through the first serial communication lane and the serial interface. The second memory cluster package communicates with the first memory cluster package through the second serial communication lane and the serial interface.

According to some implementations, a memory module includes a substrate, an allocator, a first memory cluster package, a second memory cluster package, a first serial communication lane, a second serial communication lane and a third serial communication lane. The allocator is mounted on the substrate, communicates with an external device through a compute express link (CXL) interface, and includes a first allocator-side serial communication circuit and a second allocator-side serial communication circuit. The first memory cluster package is mounted on the substrate, is controlled by the allocator, and includes a first memory controller, first memories, a first-first package-side serial communication circuit and a first-second package-side serial communication circuit. The second memory cluster package is mounted on the substrate, is controlled by the allocator, and includes a second memory controller, second memories, a second-first first package-side serial communication circuit and a second-second package-side serial communication circuit. The first serial communication lane, the second serial communication lane and the third serial communication lane are disposed on the substrate for communications between the allocator and the first and second memory cluster packages. The allocator and the first memory cluster package are electrically connected to each other through the first allocator-side serial communication circuit, the first-first package-side serial communication circuit and the first serial communication lane to communicate with each other through a serial interface. The first memory cluster package and the second memory cluster package are electrically connected to each other through the first-second package-side serial communication circuit, the second-first package-side serial communication circuit and the second serial communication lane to communicate with each other through the serial interface. a) The allocator and the second memory cluster package are electrically connected to each other through the second allocator-side serial communication circuit, the second-second package-side serial communication circuit and the third serial communication lane to communicate with each other through the serial interface, or b) the allocator and the second memory cluster package are electrically connected to each other through the first allocator-side serial communication circuit, the first-first package-side serial communication circuit, the first serial communication lane, the first-second package-side serial communication circuit, the second-first package-side serial communication circuit and the second serial communication lane to communicate with each other through the serial interface.

In some implementations, the memory cluster packages including the memories and the memory controllers may be implemented, and one memory cluster package may form one memory channel. In addition, the allocator and the memory cluster packages may communicate via the serial interface, and thus a relatively small number of pins may be used and the wiring overhead may be reduced. Further, the memory cluster packages may directly communicate with each other through the serial interface without passing through the allocator, and thus the communication overhead may be reduced. Accordingly, a relatively large number of memory channels may be implemented within the memory module, and the effective bandwidth of the memory module may be improved or enhanced.

### BRIEF DESCRIPTION OF THE DRAWINGS

Illustrative examples are described in the following detailed description taken in conjunction with the accompanying drawings.

FIG. 1 is a block diagram illustrating an example of a memory module.

FIG. 2 is a block diagram illustrating an example of an allocator included in a memory module.

FIGS. 3A, 3B and 3C are block diagrams illustrating examples of memory cluster packages included in a memory module.

FIG. 4 is a block diagram illustrating an example of a memory module corresponding to FIG. 1.

FIG. 5 is a block diagram illustrating an example of a memory module.

FIG. 6 is a block diagram illustrating an example of a memory module corresponding to FIG. 5.

FIG. 7 is a block diagram illustrating an example of a memory module.

FIG. 8 is a block diagram illustrating an example of a memory module corresponding to FIG. 7.

FIG. 9 is a block diagram illustrating an example of a memory module.

FIG. 10 is a block diagram illustrating an example of a memory module corresponding to FIG. 9.

FIG. 11 is a block diagram illustrating an example of a memory module.

FIG. 12 is a block diagram illustrating an example of a memory module corresponding to FIG. 11.

FIG. 13 is a block diagram illustrating an example of a memory included in a memory module.

FIGS. 14A and 14B are cross-sectional views of examples of a memory cluster package included in a memory module.

FIG. 15 is a block diagram illustrating an example of a computing system.

FIGS. 16A, 16B, 17A and 17B are diagrams illustrating examples of operation of a computing system.

FIG. 18 is a block diagram illustrating an example of a computing system.

FIG. 19 is a block diagram illustrating an example of a data center including a memory module.

### DETAILED DESCRIPTION

Various examples are described with reference to the accompanying drawings. The present disclosure may, however, be implemented in many different forms and should not be construed as limited to the examples set forth herein. Like reference numerals refer to like elements throughout this application.

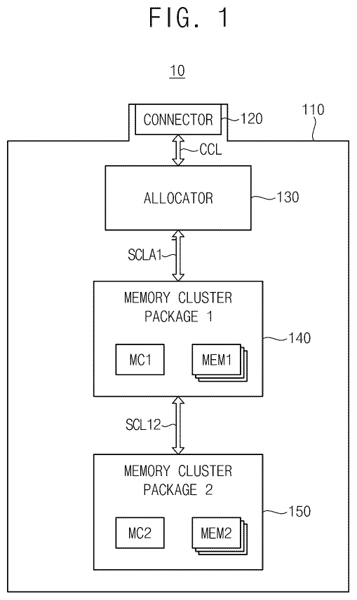

FIG. 1 is a block diagram illustrating a memory module according to some implementations of the present disclosure.

Referring to FIG. 1, a memory module 10 includes a substrate 110, an allocator 130, a plurality of memory cluster packages 140 and 150, and a plurality of serial communication lanes SCLA1 and SCL12. The memory module 10 may further include a connector 120 and a compute express link (CXL) communication lane CCL.

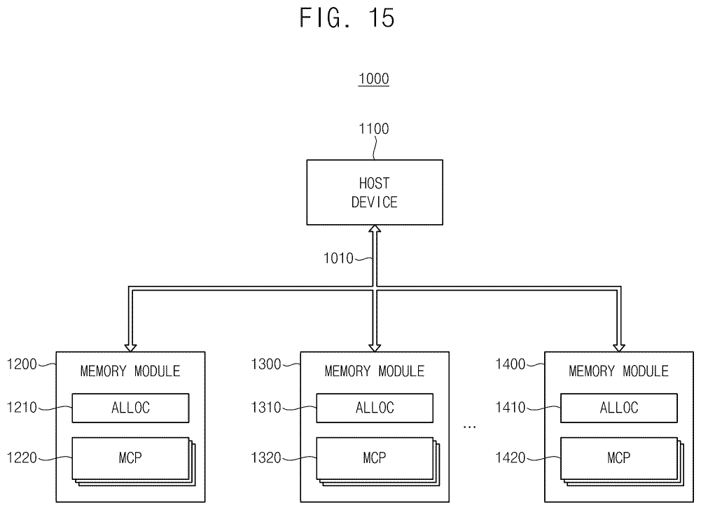

The memory module 10 may be included in a computing system that includes a host device (e.g., a central processing unit (CPU), etc.). The memory module 10 may operate under the control of the host device, and may store data. For example, the memory module 10 may communicate with the host device through (or via) an interface different from that of a conventional memory module (e.g., a dual in-line memory module (DIMM), etc.). For example, the memory module 10 may be connected to the host device without adding memory channels to the host device and may be additionally installed in the computing system regardless of conventional or existing memory technologies, and thus the memory capacity and the memory bandwidth of the computing system may efficiently increase. An example of the computing system including the memory module 10 will be described with reference to FIG. 15.

The substrate 110 may have an upper surface and a lower surface that are opposite to each other. For example, the substrate 110 may be a printed circuit board (PCB). The PCB may be a multilayered circuit board including vias and various circuits therein. The substrate 110 may be referred to as a module substrate.

The allocator 130 is mounted on the substrate 110, and communicates with an external device (e.g., the host device) through (or via) a CXL interface (e.g., an interface based on a CXL protocol). The allocator 130 may control the overall operation of the memory module 10, and may be referred to as a module controller.

The plurality of memory cluster packages 140 and 150 are mounted on the substrate 110, and are controlled by the allocator 130 and/or the host device. The plurality of memory cluster packages 140 and 150 may store data. For example, the plurality of memory cluster packages 140 and 150 may include a first memory cluster package 140 and a second memory cluster package 150, but the number of memory cluster packages is not limited thereto.

The plurality of memory cluster packages 140 and 150 include memories (or memory chips) MEM1 and MEM2, and memory controllers (or controller chips) MC1 and MC2. For example, the first memory cluster package 140 may include first memories MEM1 and a first memory controller MC1, and the second memory cluster package 150 may include second memories MEM2 and a second memory controller MC2. For example, the memories MEM1 and MEM2 may be or may include dynamic random access memories (DRAMs). Unlike conventional memory packages that only include memories, the memory cluster packages 140 and 150 may include the memories MEM1 and MEM2 and the memory controllers MC1 and MC2. In some implementations, the memories MEM1 and/or MEM2 are a memory MEM1 and/or a memory MEM2.

In some implementations, one memory cluster package and memories included therein may form a single memory channel. For example, the first memory cluster package 140 and the first memories MEM1 may form a first memory channel, and the second memory cluster package 150 and the second memories MEM2 may form a second memory channel.

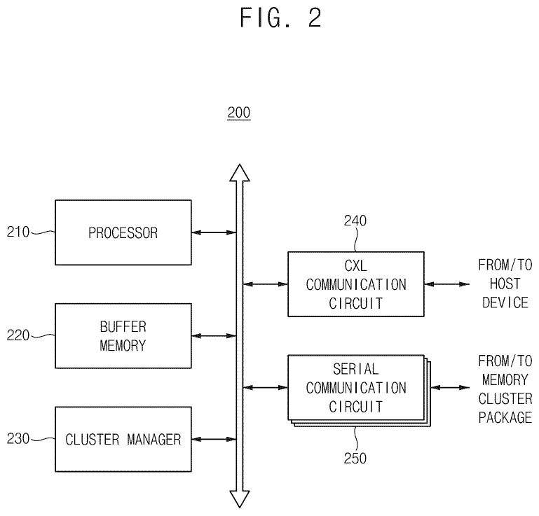

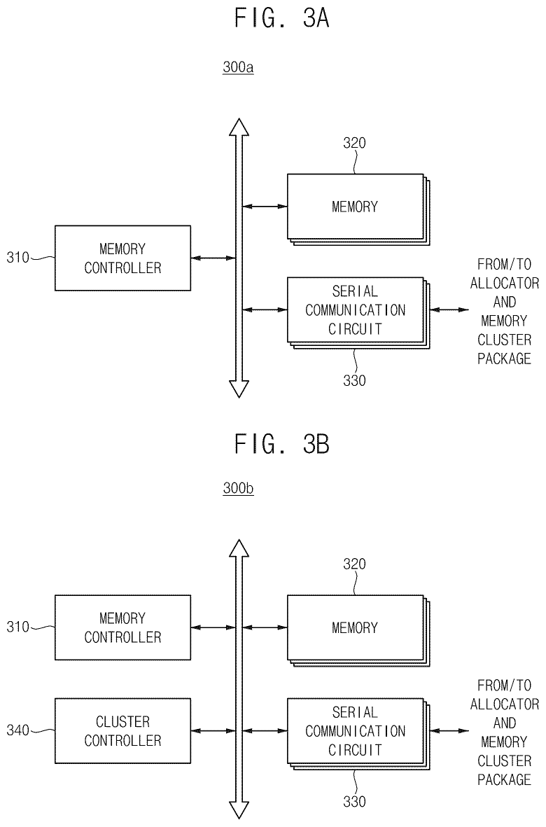

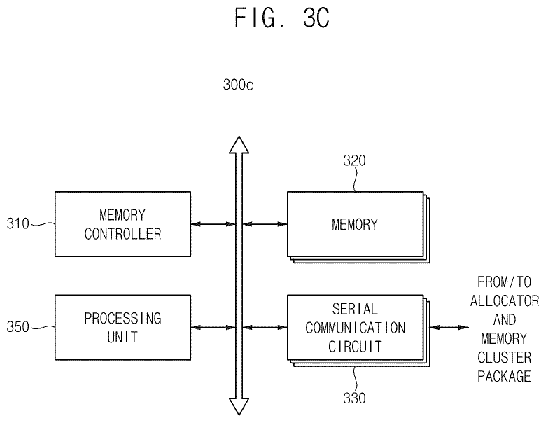

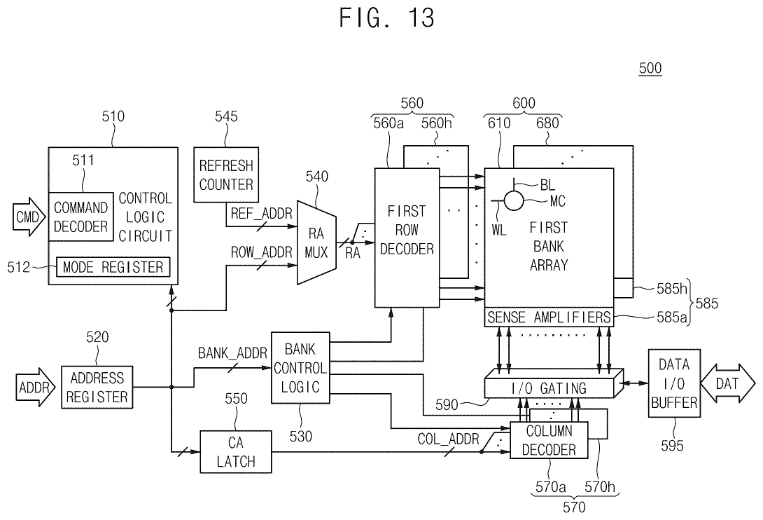

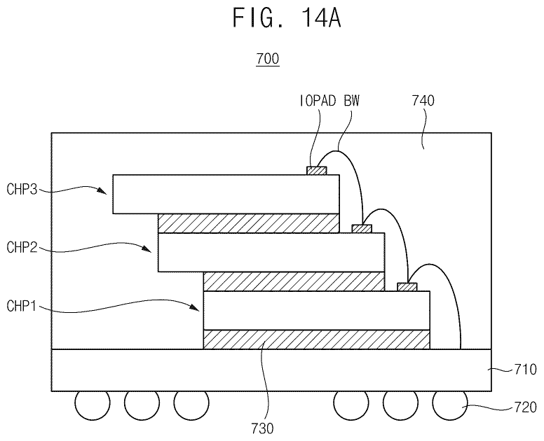

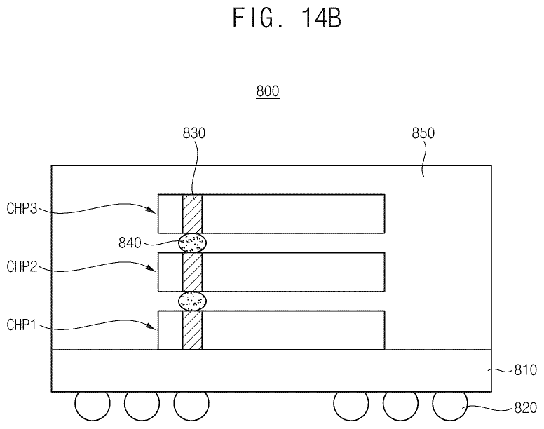

An example of the allocator 130 will be described with reference to FIG. 2, examples of the plurality of memory cluster packages 140 and 150 will be described with reference to FIGS. 3A, 3B, 3C, 14A and 14B, and an example of the memories MEM1 and MEM2 will be described with reference to FIG. 13.

The connector 120 and the CXL communication lane CCL may be formed or disposed on the substrate 110, and may be configured for an external communication of the memory module 10, e.g., an electrical connection and communication between the memory module 10 and the host device. For example, the allocator 130 may communicate with the external device through the CXL interface as described above, and thus the connector 120 and the CXL communication lane CCL may support the CXL interface.

The CXL protocol is an open standard for high-speed CPU-to-device and CPU-to-memory connections, designed for high performance data center computers. The CXL protocol is built on a peripheral component interconnect express (PCIe) physical and electrical interface with protocols in three areas: input/output (I/O), memory, and cache coherence. The CXL protocol maintains memory coherency between the direct attached CPU memory (e.g., a DRAM) and the memory on the CXL device (e.g., a memory module), which means that the CPU and the CXL device see the same data seamlessly. For example, when the CXL protocol is applied or employed, the CPU may use both the CPU memory and the CXL device as a buffer memory.

For example, the memory module 10 operating based on the CXL interface may be referred to as a CXL memory module, or simply a CXL module. The connector 120 may be referred to as a CXL connector, and the allocator 130 may be referred to as a CXL module controller, or simply a CXL controller.

Hereinafter, examples will be described in which communication between the host device and the memory module 10 is performed based on the CXL interface, but the scope of this disclosure is not limited thereto. For example, the communication between the host device and the memory module 10 may be performed using an interface implemented based on at least one of various protocols, such as a Gen-Z protocol, an NVLink protocol, a cache coherent interconnect for accelerators (CCIX) protocol, an open coherent accelerator processor interface (CAPI) protocol, etc.

The plurality of serial communication lanes SCLA1 and SCL12 may be formed or disposed on the substrate 110, and may be configured for an internal communication of the memory module 10, e.g., electrical connections and communications between the allocator 130 and the plurality of memory cluster packages 140 and 150. For example, the communications between the allocator 130 and the plurality of memory cluster packages 140 and 150 may be performed through (or via) a serial interface (e.g., an interface based on a serial communication protocol), and thus the plurality of serial communication lanes SCLA1 and SCL12 may support the serial interface. For example, each of the plurality of serial communication lanes SCLA1 and SCL12 may include at least one signal line and a clock line.

The plurality of serial communication lanes SCLA1 and SCL12 may include a first serial communication lane SCLA1 and a second serial communication lane SCL12. The first serial communication lane SCLA1 may be disposed and/or formed between the allocator 130 and the first memory cluster package 140, and the second serial communication lane SCL12 may be disposed and/or formed between the first memory cluster package 140 and the second memory cluster package 150.

The first memory cluster package 140 may be electrically connected to the allocator 130 through the first serial communication lane SCLA1, and may communicate with the allocator 130 through the first serial communication lane SCLA1 and the serial interface. For example, a communication between the allocator 130 and the first memory cluster package 140 may be performed directly through the first serial communication lane SCLA1.

The second memory cluster package 150 may be electrically connected to the first memory cluster package 140 through the second serial communication lane SCL12, and may communicate with the first memory cluster package 140 through the second serial communication lane SCL12 and the serial interface. For example, a communication between the first memory cluster package 140 and the second memory cluster package 150 may be performed directly through the second serial communication lane SCL12 without passing through the allocator 130.

The second memory cluster package 150 may be electrically connected to the allocator 130 through the first serial communication lane SCLA1 and the second serial communication lane SCL12, and may communicate with the allocator 130 through the first serial communication lane SCLA1, the second serial communication lane SCL12 and the serial interface. For example, the second memory cluster package 150 may not be directly connected to the allocator 130, and may be connected to the allocator 130 through the first memory cluster package 140. In addition, a communication between the allocator 130 and the second memory cluster package 150 may not be performed directly through a single serial communication lane, and may be performed through the first serial communication lane SCLA1, the first memory cluster package 140 and the second serial communication lane SCL12.

In some implementations, the host device transmits a data input/output (I/O) request (e.g., a write request, a read request, etc.) to the memory module 10 through the CXL interface. The allocator 130 included in the memory module 10 may receive the request based on the CXL protocol through the connector 120 and the CXL communication lane CCL, may decode the received request, and may transmit the decoded request to a corresponding memory cluster package through the serial interface. A memory controller included in the corresponding memory cluster package may transmit a data I/O command (e.g., a write command and a read command, etc.) to a memory included in the corresponding memory cluster package based on the received request, and an operation (e.g., write operations, read operations, etc.) may be performed on the memory based on the data I/O command. For example, when the write operation is performed, the write request and a corresponding write data may be provided together. For example, when the read operation is performed, read data may be output in response to the read request.

In a conventional memory module, a controller and memory packages are connected with and communicate with each other through a parallel interface such as a dual data rate (DDR) interface. In this case, there may be problems that a relatively large number of pins are required, a size of the controller is increased, and thus it is difficult to significantly increase the number of memory channels within the conventional memory module.

In some implementations of the memory module 10, the memory cluster packages 140 and 150 including the memories MEM1 and MEM2 and the memory controllers MC1 and MC2 may be implemented, and one memory cluster package may form one memory channel. In addition, the allocator 130 and the memory cluster packages 140 and 150 may communicate via the serial interface, and thus a relatively small number of pins may be used and the wiring overhead may be reduced. Further, the memory cluster packages 140 and 150 may directly communicate with each other through the serial interface without passing through the allocator 130, and thus the communication overhead may be reduced. Accordingly, a relatively large number of memory channels may be implemented within the memory module 10, and the effective bandwidth of the memory module 10 may be improved or enhanced.

FIG. 2 is a block diagram illustrating an example of an allocator included in a memory module, e.g., the allocator 130.

Referring to FIG. 2, an allocator 200 may include at least one processor 210, a buffer memory 220, a cluster manager 230, a CXL communication circuit 240 and a plurality of serial communication circuits 250.

The processor 210 may control an operation of the allocator 200 in response to requests received via the CXL communication circuit 240 from a host device (e.g., a host device 1100 in FIG. 15) located outside the allocator 200. For example, the processor 210 may control an operation of a memory module (e.g., the memory module 10 of FIG. 1), and may control respective components by employing firmware for operating the memory module.

The buffer memory 220 may store instructions and data executed and processed by the processor 210. For example, the buffer memory 220 may be implemented with a volatile memory such as a static random access memory (SRAM), a cache memory, etc.

The cluster manager 230 may control operations of a plurality of memory cluster packages (e.g., the plurality of memory cluster packages 140 and 150 in FIG. 1). For example, the cluster manager 230 may control communications between the allocator 200 and the plurality of memory cluster packages through the serial interface. In some implementations, the processor 210 and the cluster manager 230 are implemented as a single integrated circuit (IC).

The CXL communication circuit 240 may support the CXL interface, and may provide physical connections between the allocator 200 and the host device. The allocator 200 may communicate with the host device through the CXL interface using the CXL communication circuit 240. The CXL communication circuit 240 may be referred to as a CXL physical layer (PHY).

The plurality of serial communication circuits 250 may support the serial interface, and may provide physical connections between the allocator 200 and the plurality of memory cluster packages. The allocator 200 may communicate with the plurality of memory cluster packages through the serial interface using the plurality of serial communication circuits 250. The plurality of serial communication circuits 250 may be referred to as serial PHYs, and may be referred to as allocator-side serial communication circuits because they are included in the allocator 200.

In some implementations, all of the plurality of serial communication circuits 250 may are used (or utilized) for connections with the plurality of memory cluster packages. In some implementations, only some of the plurality of serial communication circuits 250 are used for connections with the plurality of memory cluster packages, while the rest of the plurality of serial communication circuits 250 are not used.

FIGS. 3A, 3B and 3C are block diagrams illustrating examples of a memory cluster package included in a memory module, e.g., memory cluster packages 140, 150.

Referring to FIG. 3A, a memory cluster package 300a may include a memory controller 310, a plurality of memories 320 and a plurality of serial communication circuits 330. For example, the memory cluster package 300a may be one of the plurality of memory cluster packages 140 and 150 in FIG. 1. In some implementations, a single serial communication circuit 330 is included.

The memory controller 310 may control operations of the plurality of memories 320. For example, the memory controller 310 may generate a command, an address, etc. for controlling the plurality of memories 320 based on a request received from an allocator (e.g., the allocator 130 in FIG. 1). In addition, the memory controller 310 may control a communication between the memory cluster package 300a and another memory cluster package.

In some implementations, the memory controller 310 includes a processor, a buffer memory, an error correction code (ECC) engine for error correction, and/or the like.

The plurality of memories 320 may be controlled by the memory controller 310, and may store a plurality of data. For example, the plurality of memories 320 may be or may include DRAMs.

The plurality of serial communication circuits 330 may support the serial interface, and may provide physical connections between the memory cluster package 300a and the allocator and/or physical connections between the memory cluster package 300a and another memory cluster package. The memory cluster package 300a may communicate with the allocator and/or another memory cluster package through the serial interface using the plurality of serial communication circuits 330. The plurality of serial communication circuits 330 may be referred to as package-side serial communication circuits because they are included in the memory cluster package 300a.

In some implementations, all of the plurality of serial communication circuits 330 mare used for connections with the allocator and other memory cluster packages. In some implementations, only some of the plurality of serial communication circuits 330 are used for connections with the plurality of memory cluster packages while the rest of the plurality of serial communication circuits 330 are not used. Additionally or alternatively, the plurality of serial communication circuits 330 may be included in the memory controller 310.

Referring to FIG. 3B, a memory cluster package 300b may include a memory controller 310, a plurality of memories 320, a plurality of serial communication circuits 330 and a cluster controller 340.

The memory cluster package 300b may be substantially the same as the memory cluster package 300a of FIG. 3A, except that the memory cluster package 300b includes the cluster controller 340. The descriptions repeated with or overlapping with descriptions of FIG. 3A will be omitted in the interest of brevity.

The cluster controller 340 may control communications between the memory cluster package 300b and other memory cluster packages. Unlike the memory cluster package 300a of FIG. 3A, the memory controller 310 that controls the operations of the plurality of memories 320 and the cluster controller 340 that controls the communications with other memory cluster packages may be implemented as separate ICs in the memory cluster package 300b. For example, the memory controller 310 and the cluster controller 340 may be implemented as different chips or different dies.

Referring to FIG. 3C, a memory cluster package 300c may include a memory controller 310, a plurality of memories 320, a plurality of serial communication circuits 330 and a processing unit (PU) 350.

The memory cluster package 300c may be substantially the same as the memory cluster package 300a of FIG. 3A, except that the memory cluster package 300c includes the processing unit 350. The descriptions repeated with or overlapping with descriptions of FIG. 3A will be omitted in the interest of brevity.

The processing unit 350 may perform computational operations on data stored in or read from the plurality of memories 320. Unlike a conventional memory package and/or a conventional memory system that may only perform a data storage function, the memory cluster package 300c including the processing unit 350 may perform both a data storage function and a data processing function together. The processing unit 350 may be referred to as a near memory processing unit (NMPU).

In some implementations, the processing unit 350 performs and/or executes computational operations, tasks (or jobs), applications, etc. off-loaded from the host device. The term “off-loading” refers to transferring resource-intensive computational tasks to a separate processor, such as a hardware accelerator, or to an external platform, such as a cluster, grid, or a cloud. Off-loading an application such as an image rendering application or a mathematical computation to a co-processor is used to accelerate the application or mathematical computation. Off-loading applications and computations to an external platform over a network may provide increased computing power and help to overcome hardware limitations of a device, such as limited computational power, storage, and energy.

In some implementations, the memory controller 310 and the processing unit 350 are implemented as a single IC.

The memory cluster package may include any or all of the memory controller 310, the cluster controller 340, and the processing unit 350.

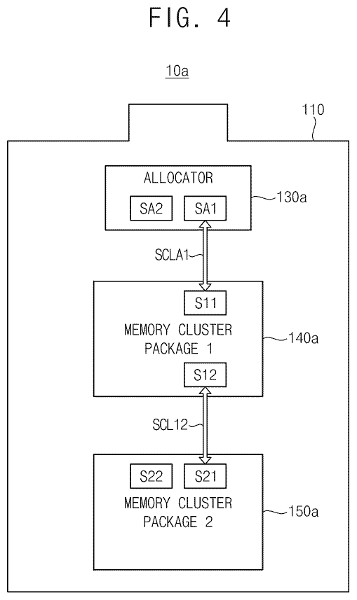

FIG. 4 is a block diagram illustrating an example of a memory module, e.g., the memory module 10 of FIG. 1. Referring to FIG. 4, a memory module 10a may include a substrate 110, an allocator 130a, a plurality of memory cluster packages 140a and 150a, and a plurality of serial communication lanes SCLA1 and SCL12. For convenience of illustration, some components (e.g., the connector 120, the CXL communication lane CCL, the memories MEM1 and MEM2, and the memory controllers MC1 and MC2 in FIG. 1) are omitted from FIG. 4.

The allocator 130a may include a plurality of serial communication circuits SA1 and SA2. The first memory cluster package 140a may include a plurality of serial communication circuits S11 and S12. The second memory cluster package 150a may include a plurality of serial communication circuits S21 and S22. The plurality of serial communication circuits SA1 and SA2 may be referred to as allocator-side serial communication circuits, the plurality of serial communication circuits S11 and S12 may be referred to as first package-side serial communication circuits, and the plurality of serial communication circuits S21 and S22 may be referred to as second package-side serial communication circuits.

The serial communication circuit SA1 in the allocator 130a may be electrically connected to the first memory cluster package 140a through the first serial communication lane SCLA1, and the serial communication circuit S11 in the first memory cluster package 140a may be electrically connected to the allocator 130a through the first serial communication lane SCLA1. For example, the allocator 130a and the first memory cluster package 140a may be electrically connected to each other through the first allocator-side serial communication circuit SA1, the first-first package-side serial communication circuit S11 and the first serial communication lane SCLA1 to communicate with each other through the serial interface.

The serial communication circuit S12 in the first memory cluster package 140a may be electrically connected to the second memory cluster package 150a through the second serial communication lane SCL12, and the serial communication circuit S21 in the second memory cluster package 150a may be electrically connected to the first memory cluster package 140a through the second serial communication lane SCL12. For example, the first memory cluster package 140a and the second memory cluster package 150a may be electrically connected to each other through the first-second package-side serial communication circuit S12, the second-first package-side serial communication circuit S21 and the second serial communication lane SCL12 to communicate with each other through the serial interface.

The allocator 130a and the second memory cluster package 150a may be electrically connected to each other through the first allocator-side serial communication circuit SA1, the first-first package-side serial communication circuit S11, the first serial communication lane SCLA1, the first-second package-side serial communication circuit S12, the second-first package-side serial communication circuit S21 and the second serial communication lane SCL12 to communicate with each other through the serial interface.

In some implementations, as shown in FIG. 4, among the plurality of serial communication circuits SA1 and SA2 in the allocator 130a, the remaining serial communication circuits other than the first allocator-side serial communication circuit SA1, e.g., the second allocator-side serial communication circuit SA2, may be electrically disconnected from the plurality of serial communication lanes SCLA1 and SCL12 and the plurality of memory cluster packages 140a and 150a. For example, FIG. 4 illustrates an example in which only some of the serial communication circuits SA1 and SA2 are used, and the rest of the serial communication circuits SA1 and SA2 are not used.

Similarly, among the plurality of serial communication circuits S21 and S22 in the second memory cluster package 150a, the remaining serial communication circuits other than the second-first package side serial communication circuit S21, e.g., the second-second package side serial communication circuit S22, may be electrically disconnected from the plurality of serial communication lanes SCLA1 and SCL12, the allocator 130a and another memory cluster package 140a, and may not be used.

In contrast, all of the plurality of serial communication circuits S11 and S12 in the first memory cluster package 140a may be electrically connected to the plurality of serial communication lanes SCLA1 and SCL12, the allocator 130a and another memory cluster package 150a, and may be used.

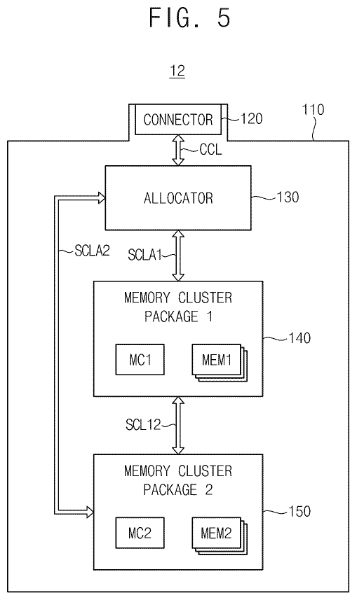

FIG. 5 is a block diagram illustrating a memory module according to some impolementations. The descriptions repeating or overlapping with descriptions of FIG. 1 will be omitted in the interest of brevity.

Referring to FIG. 5, a memory module 12 includes a substrate 110, an allocator 130, a plurality of memory cluster packages 140 and 150, and a plurality of serial communication lanes SCLA1, SCLA2 and SCL12. The memory module 12 may further include a connector 120 and a CXL communication lane CCL.

The memory module 12 may be substantially the same as the memory module 10 of FIG. 1, except that the memory module 12 further includes a third serial communication lane SCLA2. The third serial communication lane SCLA2 may be disposed and/or formed between the allocator 130 and the second memory cluster package 150.

In some implementations, as shown in FIG. 5, the second memory cluster package 150 may be electrically connected to the allocator 130 through the third serial communication lane SCLA2, and may communicate with the allocator 130 through the third serial communication lane SCLA2 and the serial interface. For example, a communication between the allocator 130 and the second memory cluster package 150 may be performed directly through the third serial communication lane SCLA2.

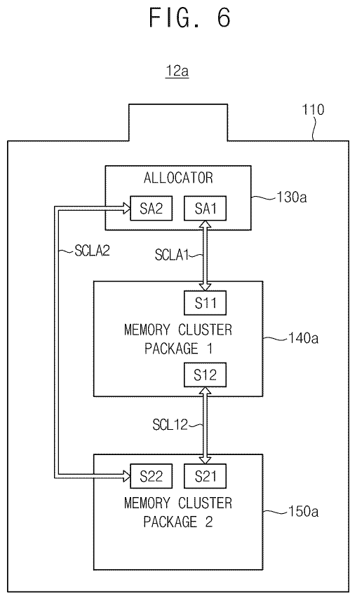

FIG. 6 is a block diagram illustrating an example of a memory module, e.g., the memory module 12 of FIG. 5. The descriptions repeated with or overlapping with descriptions of FIG. 4 will be omitted in the interest of brevity.

Referring to FIG. 6, a memory module 12a may include a substrate 110, an allocator 130a, a plurality of memory cluster packages 140a and 150a, and a plurality of serial communication lanes SCLA1, SCLA2 and SCL12. The memory module 12a may be substantially the same as the memory module 10a of FIG. 4, except that the memory module 12a further includes a third serial communication lane SCLA2.

The serial communication circuit SA2 in the allocator 130a may be electrically connected to the second memory cluster package 150a through the third serial communication lane SCLA2, and the serial communication circuit S22 in the second memory cluster package 150a may be electrically connected to the allocator 130a through the third serial communication lane SCLA2. For example, the allocator 130a and the second memory cluster package 150a may be electrically connected to each other through the second allocator-side serial communication circuit SA2, the second-second package-side serial communication circuit S22 and the third serial communication lane SCLA2 to communicate with each other through the serial interface.

In some implementations, as shown in FIG. 6, all of the plurality of serial communication circuits SA1 and SA2 in the allocator 130a may be electrically connected to the serial communication lanes SCLA1 and SCLA2 and the plurality of memory cluster packages 140a and 150a. For example, FIG. 6 illustrates an example where all of the serial communication circuits SA1 and SA2 are used. Similarly, all of the plurality of serial communication circuits S21 and S22 in the second memory cluster package 150a may be electrically connected to the serial communication lanes SCLA2 and SCL12, the allocator 130a and another memory cluster package 140a, and may be used.

Although FIGS. 4 and 6 illustrate examples where each of the allocator 130a and the memory cluster packages 140a and 150a includes two serial communication circuits, e.g., examples where the number of serial communication circuits included in each component is equal to the number of memory cluster packages (or the number of memory channels) included in the memory module, examples within the scope of this disclosure are not limited thereto, and the number of serial communication circuits included in each component may be variously determined. For example, each component may include one, two, three, or more serial communication circuits. For example, the first memory cluster package 140a may include three or more serial communication circuits, in which case, for the configurations of FIGS. 4 and 6, only some of the serial communication circuits in the first memory cluster package 140a may be used, and the rest of the serial communication circuits in the first memory cluster package 140a may not be used.

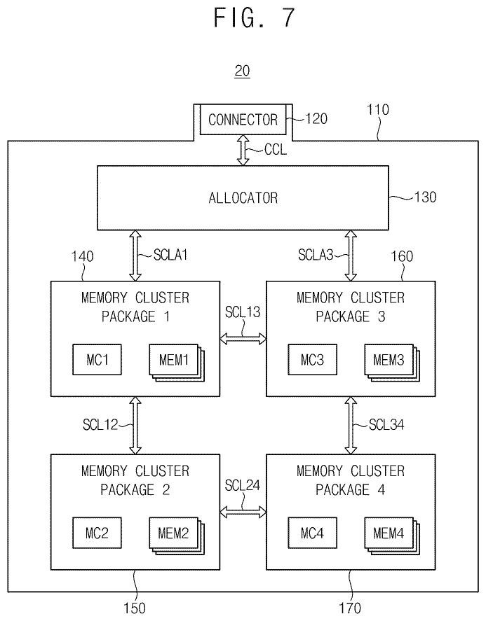

FIG. 7 is a block diagram illustrating a memory module according to some implementations. The descriptions repeated with or overlapping with descriptions of FIG. 1 will be omitted in the interest of brevity.

Referring to FIG. 7, a memory module 20 includes a substrate 110, an allocator 130, a plurality of memory cluster packages 140, 150, 160 and 170, and a plurality of serial communication lanes SCLA1, SCLA3, SCL12, SCL13, SCL24 and SCL34. The memory module 20 may further include a connector 120 and a CXL communication lane CCL.

The memory module 20 may be similar to the memory module 10 of FIG. 1, except that the memory module 20 further includes the memory cluster packages 160 and 170 and the serial communication lanes SCLA3, SCL13, SCL24 and SCL34.

A third memory cluster package 160 may include third memories MEM3 and a third memory controller MC3, and a fourth memory cluster package 170 may include fourth memories MEM4 and a fourth memory controller MC4. Each of the third and fourth memory cluster packages 160 and 170 may be implemented as described with reference to FIGS. 3A, 3B and 3C.

The serial communication lane SCLA3 may be disposed and/or formed between the allocator 130 and the third memory cluster package 160, and the serial communication lane SCL34 may be disposed and/or formed between the third memory cluster package 160 and the fourth memory cluster package 170. The serial communication lane SCL13 may be disposed and/or formed between the first memory cluster package 140 and the third memory cluster package 160, and the serial communication lane SCL24 may be disposed and/or formed between the second memory cluster package 150 and the fourth memory cluster package 170.

The third memory cluster package 160 may be electrically connected to the allocator 130 through the serial communication lane SCLA3, and may directly communicate with the allocator 130 through the serial communication lane SCLA3 and the serial interface. The fourth memory cluster package 170 may be electrically connected to the third memory cluster package 160 through the serial communication lane SCL34, and may directly communicate with the third memory cluster package 160 through the serial communication lane SCL34 and the serial interface. The fourth memory cluster package 170 may be electrically connected to the allocator 130 through the serial communication lanes SCLA3 and SCL34, and may communicate with the allocator 130 through the serial communication lanes SCLA3 and SCL34 and the serial interface.

Additionally, the first and third memory cluster packages 140 and 160 may be electrically connected to each other through the serial communication lane SCL13, and may directly communicate with each other through the serial communication lane SCL13 and the serial interface. The second and fourth memory cluster packages 150 and 170 may be electrically connected to each other through the serial communication lane SCL24, and may directly communicate with each other through the serial communication lane SCL24 and the serial interface.

In the memory module 20, the allocator 130 and the memory cluster packages 140, 150, 160 and 170 may be electrically connected to each other via the serial communication lanes SCLA1, SCLA3, SCL12, SCL13, SCL24 and SCL34, and may communicate with each other via the serial interface. Accordingly, the number of memory channels may be increased without excessively increasing the number of pins, and the effective bandwidth of the memory module 20 may be improved or enhanced.

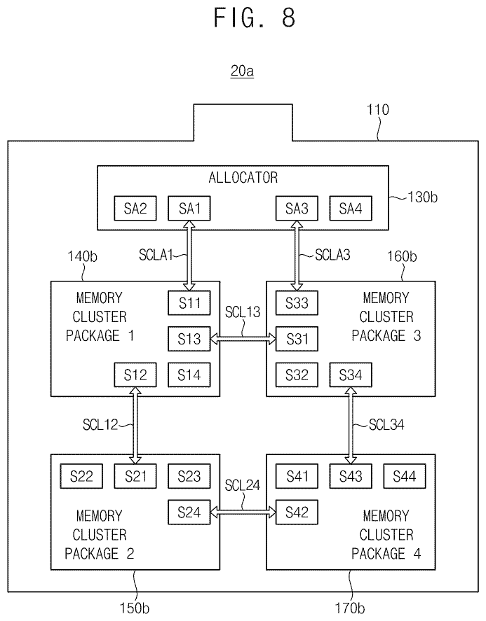

FIG. 8 is a block diagram illustrating an example of a memory module, e.g., the memory module 20 of FIG. 7. The descriptions repeated with or overlapping with descriptions of FIG. 4 will be omitted in the interest of brevity.

Referring to FIG. 8, a memory module 20a may include a substrate 110, an allocator 130b, a plurality of memory cluster packages 140b, 150b, 160b and 170b, and a plurality of serial communication lanes SCLA1, SCLA3, SCL12, SCL13, SCL24 and SCL34.

The allocator 130b may include a plurality of serial communication circuits SA1, SA2, SA3 and SA4. The first memory cluster package 140b may include a plurality of serial communication circuits S11, S12, S13 and S14. The second memory cluster package 150b may include a plurality of serial communication circuits S21, S22, S23 and S24. The third memory cluster package 160b may include a plurality of serial communication circuits S31, S32, S33 and S34. The fourth memory cluster package 170b may include a plurality of serial communication circuits S41, S42, S43 and S44. The plurality of serial communication circuits S31, S32, S33 and S34 may be referred to as third package-side serial communication circuits, and the plurality of serial communication circuits S41, S42, S43 and S44 may be referred to as fourth package-side serial communication circuits.

The serial communication circuit SA3 in the allocator 130b may be electrically connected to the third memory cluster package 160b through the serial communication lane SCLA3, and the serial communication circuit S33 in the third memory cluster package 160b may be electrically connected to the allocator 130b through the serial communication lane SCLA3. Thus, the allocator 130b and the third memory cluster package 160b may directly communicate with each other through the serial communication lane SCLA3 and the serial interface.

The serial communication circuit S34 in the third memory cluster package 160b may be electrically connected to the fourth memory cluster package 170b through the serial communication lane SCL34, and the serial communication circuit S43 in the fourth memory cluster package 170b may be electrically connected to the third memory cluster package 160b through the serial communication lane SCL34. Thus, the third memory cluster package 160b and the fourth memory cluster package 170b may directly communicate with each other through the serial communication lane SCL34 and the serial interface.

The allocator 130b and the fourth memory cluster package 170b may be electrically connected to each other through the serial communication circuit SA3 in the allocator 130b, the serial communication circuit S33 in the third memory cluster package 160b, the serial communication lane SCLA3, the serial communication circuit S34 in the third memory cluster package 160b, the serial communication circuit S43 in the fourth memory cluster package 170b and the serial communication lane SCL34. Thus, the allocator 130b and the fourth memory cluster package 170b may communicate with each other through the serial communication lanes SCLA3 and SCL34 and the serial interface.

The serial communication circuit S13 in the first memory cluster package 140b may be electrically connected to the third memory cluster package 160b through the serial communication lane SCL13, and the serial communication circuit S31 in the third memory cluster package 160b may be electrically connected to the first memory cluster package 140b through the serial communication lane SCL13. Thus, the first memory cluster package 140b and the third memory cluster package 160b may directly communicate with each other through the serial communication lane SCL13 and the serial interface.

The serial communication circuit S24 in the second memory cluster package 150b may be electrically connected to the fourth memory cluster package 170b through the serial communication lane SCL24, and the serial communication circuit S42 in the fourth memory cluster package 170b may be electrically connected to the second memory cluster package 150b through the serial communication lane SCL24. Thus, the second memory cluster package 150b and the fourth memory cluster package 170b may directly communicate with each other through the serial communication lane SCL24 and the serial interface.

In the example of FIG. 8, the serial communication circuits SA2, SA4, SA14, SA22, SA23, SA32, SA41 and SA44 may not be used.

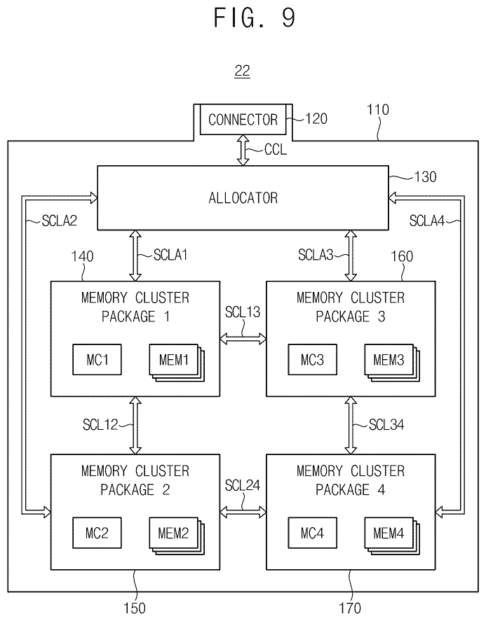

FIG. 9 is a block diagram illustrating a memory module according to some implementations. The descriptions repeated with or overlapping with descriptions of FIGS. 5 and 7 will be omitted in the interest of brevity.

Referring to FIG. 9, a memory module 22 includes a substrate 110, an allocator 130, a plurality of memory cluster packages 140, 150, 160 and 170, and a plurality of serial communication lanes SCLA1, SCLA2, SCLA3, SCLA4, SCL12, SCL13, SCL24 and SCL34. The memory module 22 may further include a connector 120 and a CXL communication lane CCL.

The memory module 22 may be substantially the same as the memory module 20 of FIG. 7, except that the memory module 22 further includes the serial communication lanes SCLA2 and SCLA4. The serial communication lane SCLA2 may be substantially the same as the serial communication lane SCLA2 in FIG. 5.

In some implementations, as shown in FIG. 9, the fourth memory cluster package 170 may be electrically connected to the allocator 130 through the serial communication lane SCLA4, and may directly communicate with the allocator 130 through the serial communication lane SCLA4 and the serial interface.

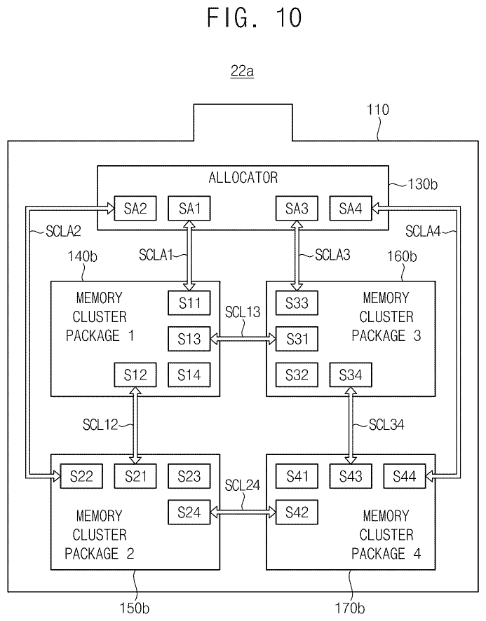

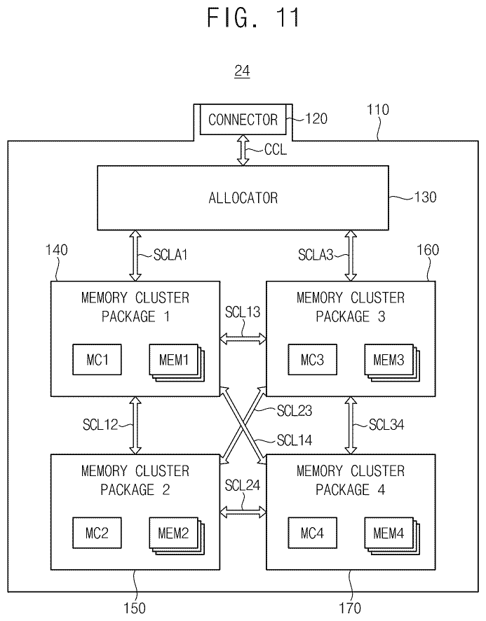

FIG. 10 is a block diagram illustrating an example of a memory module, e.g., memory module 22 of FIG. 9. The descriptions repeated with or overlapping with descriptions of FIGS. 6 and 8 will be omitted in the interest of brevity.

Referring to FIG. 10, a memory module 22a may include a substrate 110, an allocator 130b, a plurality of memory cluster packages 140b, 150b, 160b and 170b, and a plurality of serial communication lanes SCLA1, SCLA2, SCLA3, SCLA4, SCL12, SCL13, SCL24 and SCL34.

The memory module 22a may be substantially the same as the memory module 20a of FIG. 8, except that the memory module 22a further includes the serial communication lanes SCLA2 and SCLA4. The serial communication lane SCLA2 may be substantially the same as the serial communication lane SCLA2 in FIG. 6.

The serial communication circuit SA4 in the allocator 130b may be electrically connected to the fourth memory cluster package 170b through the serial communication lane SCLA4, and the serial communication circuit S44 in the fourth memory cluster package 170b may be electrically connected to the allocator 130b through the serial communication lane SCLA4. Thus, the allocator 130b and the fourth memory cluster package 170b may directly communicate with each other through the serial communication lane SCLA4 and the serial interface.

In some implementations, as shown in FIG. 10, the serial communication circuits SA14, SA23, SA32 and SA44 may not be used.

FIG. 11 is a block diagram illustrating a memory module according to some implementations. The descriptions repeated with or overlapping with descriptions of FIG. 7 will be omitted in the interest of brevity.

Referring to FIG. 11, a memory module 24 includes a substrate 110, an allocator 130, a plurality of memory cluster packages 140, 150, 160 and 170, and a plurality of serial communication lanes SCLA1, SCLA3, SCL12, SCL13, SCL14, SCL23, SCL24 and SCL34. The memory module 24 may further include a connector 120 and a CXL communication lane CCL.

The memory module 24 may be substantially the same as the memory module 20 of FIG. 7, except that the memory module 24 further includes the serial communication lanes SCL14 and SCL23.

In some implementations, as shown in FIG. 11, the first and fourth memory cluster packages 140 and 170 may be electrically connected to each other through the serial communication lane SCL14, and may communicate directly with each other through the serial communication lane SCL14 and the serial interface. The second and third memory cluster packages 150 and 160 may be electrically connected to each other through the serial communication lane SCL23, and may communicate directly with each other through the serial communication lane SCL23 and the serial interface.

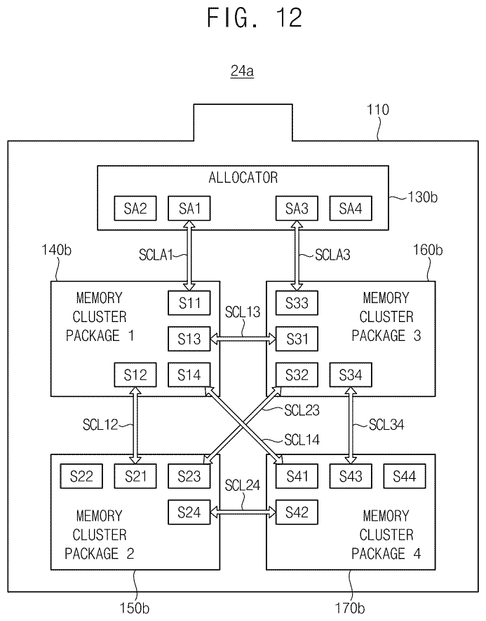

FIG. 12 is a block diagram illustrating an example of a memory module, e.g., memory module 24 of FIG. 11. The descriptions repeated with or overlapping with descriptions of FIG. 8 will be omitted in the interest of brevity.

Referring to FIG. 12, a memory module 24a may include a substrate 110, an allocator 130b, a plurality of memory cluster packages 140b, 150b, 160b and 170b, and a plurality of serial communication lanes SCLA1, SCLA3, SCL12, SCL13, SCL14, SCL23, SCL24 and SCL34.

The memory module 24a may be substantially the same as the memory module 20a of FIG. 8, except that the memory module 24a further includes the serial communication lanes SCL14 and SCL23.

The serial communication circuit S14 in the first memory cluster package 140b may be electrically connected to the fourth memory cluster package 170b through the serial communication lane SCL14, and the serial communication circuit S41 in the fourth memory cluster package 170b may be electrically connected to the first memory cluster package 140b through the serial communication lane SCL14. Thus, the first memory cluster package 140b and the fourth memory cluster package 170b may directly communicate with each other through the serial communication lane SCL14 and the serial interface.

The serial communication circuit S23 in the second memory cluster package 150b may be electrically connected to the third memory cluster package 160b through the serial communication lane SCL23, and the serial communication circuit S32 in the third memory cluster package 160b may be electrically connected to the second memory cluster package 150b through the serial communication lane SCL23. Thus, the second memory cluster package 150b and the third memory cluster package 160b may directly communicate with each other through the serial communication lane SCL23 and the serial interface.

In some implementations, as shown in FIG. 12, the serial communication circuits SA2, SA4, SA22 and SA44 may not be used.

Although configurations of serial communication lanes and serial communication circuits in the memory module including four memory cluster packages are described with reference to FIGS. 7 through 12, examples within the scope of this disclosure are not limited thereto. For example, all of the serial communication lanes SCLA1, SCLA2, SCLA3, SCLA4, SCL12, SCL13, SCL14, SCL23, SCL24 and SCL34 may be included, or at least one of the serial communication lanes SCLA1, SCLA2, SCLA3, SCLA4, SCL12, SCL13, SCL14, SCL23, SCL24 and SCL34 may be omitted. For example, the availability of each of the serial communication circuits SA1, SA2, SA3, SA4, S11, S12, S13, S14, S21, S22, S23, S24, S31, S32, S33, S34, S41, S42, S43 and S44 may be determined depending on the configuration of serial communication lanes.

Further, although the foregoing examples include specific numbers of memory cluster packages, the specific numbers of serial communication lanes, and specific numbers of serial communication circuits, examples within the scope of this disclosure are not limited to those numbers, and memory modules within the scope of this disclosure may include an arbitrary number of memory cluster packages, an arbitrary number of serial communication lanes, and/or an arbitrary number of serial communication circuits.

FIG. 13 is a block diagram illustrating an example of a memory included in a memory module.

Referring to FIG. 13, a memory 500 may include a memory cell array 600, a control logic circuit 510, an address register 520, a bank control logic circuit 530, a row address multiplexer 540, a refresh counter 545, a column address latch 550, a row decoder 560, a column decoder 570, a sense amplifier circuit (or unit) 585, an input/output (I/O) gating circuit 590 and a data I/O buffer 595. For example, the memory 500 may be one of various volatile memories such as a DRAM.

The memory cell array 600 may include first to eighth bank arrays 610 to 680. The row decoder 560 may include first to eighth bank row decoders 560a to 560h connected respectively to the first to eighth bank arrays 610 to 680. The column decoder 570 may include first to eighth bank column decoders 570a to 570h connected respectively to the first to eighth bank arrays 610 to 680. The sense amplifier circuit 585 may include first to eighth bank sense amplifiers 585a to 585h connected respectively to the first to eighth bank arrays 610 to 680.

The first to eighth bank arrays 610 to 680, the first to eighth bank row decoders 560a to 560h, the first to eighth bank column decoders 570a to 570h, and the first to eighth bank sense amplifiers 585a to 585h may form first to eighth banks. Each of the first to eighth bank arrays 610 to 680 may include a plurality of wordlines WL, a plurality of bitlines BL, and a plurality of memory cells MC that are at intersections of the wordlines WL and the bitlines BL.

Although FIG. 13 illustrates the memory 500 including eight banks (and eight bank arrays, eight row decoders, and so on), the memory 500 may include any number of banks; for example, one, two, four, eight, sixteen, or thirty two banks, or any number therebetween one and thirty two, or another number.

The address register 520 may receive an address ADDR including a bank address BANK_ADDR, a row address ROW_ADDR, and a column address COL_ADDR from a memory controller. The address register 520 may provide the received bank address BANK_ADDR to the bank control logic circuit 530, may provide the received row address ROW_ADDR to the row address multiplexer 540, and may provide the received column address COL_ADDR to the column address latch 550.

The bank control logic circuit 530 may generate bank control signals in response to the bank address BANK_ADDR. One of the first to eighth bank row decoders 560a to 560h corresponding to the bank address BANK_ADDR may be activated in response to the bank control signals, and one of the first to eighth bank column decoders 570a to 570h corresponding to the bank address BANK_ADDR may be activated in response to the bank control signals.

The row address multiplexer 540 may receive the row address ROW_ADDR from the address register 520, and may receive a refresh row address REF_ADDR from the refresh counter 545. The row address multiplexer 540 may selectively output the row address ROW_ADDR or the refresh row address REF_ADDR as a row address RA. The row address RA that is output from the row address multiplexer 540 may be applied to the first to eighth bank row decoders 560a to 560h.

The activated one of the first to eighth bank row decoders 560a to 560h may decode the row address RA that is output from the row address multiplexer 540, and may activate in the corresponding bank array a wordline WL corresponding to the row address RA. For example, the activated bank row decoder may generate a wordline driving voltage, and may apply the wordline driving voltage to the wordline WL corresponding to the row address RA.

The column address latch 550 may receive the column address COL_ADDR from the address register 520, and may temporarily store the received column address COL_ADDR. In some implementations, in a burst mode, the column address latch 550 may generate column addresses that increment from the received column address COL_ADDR. The column address latch 550 may apply the temporarily stored or generated column address to the first to eighth bank column decoders 570a to 570h.

The activated one of the first to eighth bank column decoders 570a to 570h may decode the column address COL_ADDR that is output from the column address latch 550, and may control the I/O gating circuit 590 to output data corresponding to the column address COL_ADDR.

The I/O gating circuit 590 may include circuitry configured to gate input/output data. The I/O gating circuit 590 may further include read data latches configured to store data that is output from the first to eighth bank arrays 610 to 680, and may also include write control devices for writing data to the first to eighth bank arrays 610 to 680.

Data DAT read from one of the first to eighth bank arrays 610 to 680 may be sensed by a sense amplifier connected to the one bank array from which the data DAT is to be read, and may be stored in the read data latches. The data DAT stored in the read data latches may be provided to the memory controller via the data I/O buffer 595. Data DAT to be written in one of the first to eighth bank arrays 610 to 680 may be provided to the I/O gating circuit 590 via the data I/O buffer 595 from the memory controller, and the I/O gating circuit 590 may write the data DAT in the one bank array through the write drivers.

The control logic circuit 510 may control operations of the memory 500. For example, the control logic circuit 510 may generate control signals for the memory 500 to perform the write operation and/or the read operation. The control logic circuit 510 may include a command decoder 511 that decodes a command CMD received from the memory controller, and a mode register 512 that sets an operation mode of the memory 500.

Although the memory of FIG. 13 is described based on a DRAM, the memory included in the memory modules described herein may be any volatile and/or nonvolatile memories, e.g., an SRAM, a flash memory, a phase-change random access memory (PRAM), a resistive random access memory (RRAM), a magnetic random access memory (MRAM), a ferroelectric random access memory (FRAM), or the like.

FIGS. 14A and 14B are cross-sectional views of examples of a memory cluster package included in a memory module. Referring to FIG. 14A, a memory cluster package 700 includes a base substrate (or package substrate) 710 and a plurality of chips CHP1, CHP2 and CHP3 stacked on the base substrate 710.

Each of the chips CHP1 to CHP3 may include a plurality of I/O pads IOPAD. One of the chips CHP1 to CHP3 may be a controller chip corresponding to a control element (e.g., the memory controller 310, the cluster controller 340 and/or the processing unit 350 in FIGS. 3A, 3B and 3C) included in a memory cluster package. The remaining chips other than the controller chip among the chips CHP1 to CHP3 may be memory chips corresponding to memories included in the memory cluster package.

In some implementations, the chips CHP1 to CHP3 are stacked on the base substrate 710 such that a surface on which the plurality of I/O pads IOPAD are formed faces upwards. In some implementations, with respect to each of the chips CHP1 to CHP3, the plurality of I/O pads IOPAD are arranged near one side of a semiconductor substrate. As such, the chips CHP1 to CHP3 may be stacked scalariformly or stepwisely, that is, in a step shape, such that the plurality of I/O pads IOPAD of each chip may be exposed. In such stacked state, the chips CHP1 to CHP3 may be electrically connected to the base substrate 710 through a plurality of bonding wires BW.

The stacked chips CHP1 to CHP3 and the plurality of bonding wires BW may be fixed by a sealing member 740, and adhesive members 730 may intervene between the base substrate 710 and the chips CHP1 to CHP3. Conductive bumps 720 may be formed on a bottom surface of the base substrate 710 for electrical connections to an external device.

Referring to FIG. 14B, a memory cluster package 800 includes a base substrate 810 and a plurality of chips CHP1 to CHP3 stacked on the base substrate 810. The descriptions repeated with or overlapping with descriptions of FIG. 14A will be omitted in the interest of brevity.

Each of the chips CHP1 to CHP3 may include a plurality of through silicon vias (TSVs) 830.

In some implementations, with respect to each of the chips CHP1 to CHP3, the plurality of TSVs 830 are arranged at the same locations in each chip. As such, the chips CHP1 to CHP3 may be stacked such that the plurality of TSVs 830 of each chip may be completely overlapped (e.g., arrangements of the plurality of TSVs 830 may be matched in the chips CHP1 to CHP3). In such stacked state, the chips CHP1 to CHP3 may be electrically connected to one another and the base substrate 810 through the plurality of TSVs 830 and conductive material 840.

Conductive bumps 820 and a sealing member 850 may be substantially the same as the conductive bumps 720 and the sealing member 740 in FIG. 14A, respectively.

However, implementations are not limited thereto, and a plurality of chips (e.g., the controller chip and the memory chips) included in a memory cluster package may be implemented with various structures and arrangements of packages and chips.

FIG. 15 is a block diagram illustrating an example of a computing system.

Referring to FIG. 15, a computing system 1000 includes a host device 1100 and a plurality of memory modules 1200, 1300 and 1400. The computing system 1000 may further include a bus 1010.

The host device 1100 controls overall operations of the computing system 1000. For example, the host device 1100 may include at least one of various processing units, e.g., a CPU, or the like. For example, the host device 1100 may execute an operating system (OS). The operating system may include, for example, a file system for file management and a device driver for controlling peripheral devices at the operating system level.

The plurality of memory modules 1200, 1300 and 1400 are connected to the host device 1100 through the bus 1010, and communicate with the host device 1100 through the CXL interface. For example, the host device 1100 may include a CXL communication circuit that supports the CXL interface, and the bus 1010 may be referred to as a CXL bus. However, the scope of this disclosure is not limited thereto, and the host device 1100 and the plurality of memory modules 1200, 1300 and 1400 may communicate with each other using an interface implemented based on at least one of various protocols, such as a Gen-Z protocol, an NVLink protocol, a CCIX protocol, an open CAPI protocol, etc.

Each of the plurality of memory modules 1200, 1300 and 1400 may be a memory module as described with reference to FIGS. 1 through 12. For example, the memory module 1200 may include an allocator (ALLOC) 1210 and a plurality of memory cluster packages (MCPs) 1220, the memory module 1300 may include an allocator 1310 and a plurality of memory cluster packages 1320, and the memory module 1400 may include an allocator 1410 and a plurality of memory cluster packages 1420. In each of the plurality of memory modules 1200, 1300 and 1400, one memory cluster package may form one memory channel, and internal communications between the allocators 1210, 1310 and 1410 and the memory cluster packages 1220, 1320 and 1420 may be performed through the serial interface. Accordingly, a relatively small number of pins may be used and the wiring overhead may be reduced, the memory cluster packages may directly communicate with each other and the communication overhead may be reduced, a relatively large number of memory channels may be implemented within the memory module, and the effective bandwidth of the memory module may be improved or enhanced.

In some implementations, the computing system 1000 includes at least one accelerator that includes a processing unit having a type different from that of the processing unit included in the host device 1100. For example, the accelerator may include at least one of various processing units performing artificial intelligence (AI) computations, e.g., a graphic processing unit (GPU), a tensor processing unit (TPU), a neural processing unit (NPU), a vision processing unit (VPU), etc. Different types of processing units (or heterogeneous processing units) may be included in the computing system, and thus the computing system may be referred to as a heterogeneous computing system.

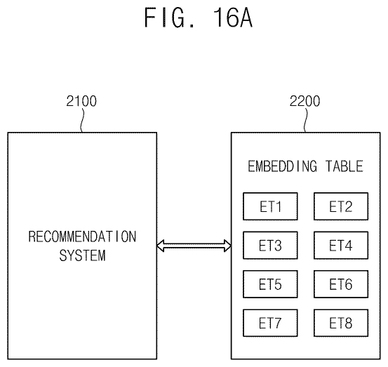

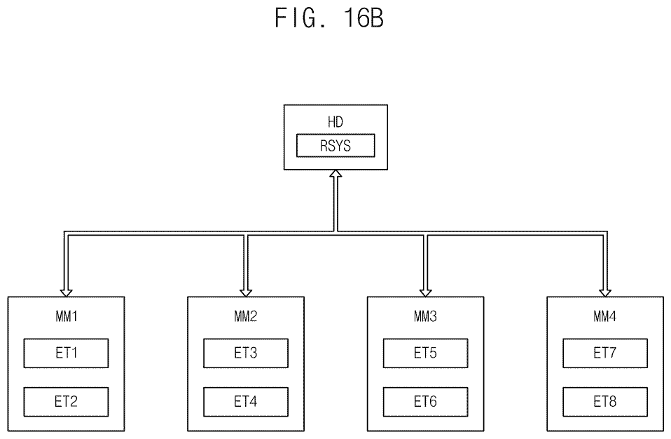

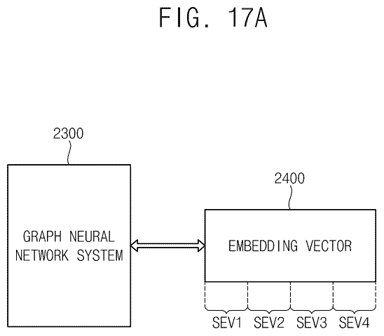

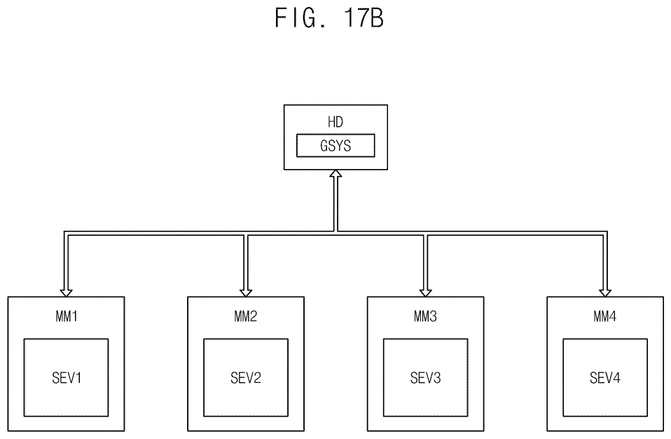

FIGS. 16A, 16B, 17A and 17B are diagrams describing an operation of a computing system according to some implementations.

Referring to FIG. 16A, an example of a recommendation system (or recommender system) 2100 executed by a computing system is illustrated.

Various data and/or information may be used to execute the recommendation system 2100. For example, to execute the recommendation system 2100, various computational operations may be performed on the various data and/or information using a plurality of embedding tables 2200. For example, the plurality of embedding tables 2200 may include first to eighth embedding tables ET1, ET2, ET3, ET4, ET5, ET6, ET7 and ET8, but the scope of this disclosure is not limited thereto.

Recommendation systems or recommender systems may be an intuitive line of defense against consumer over-choice. Given the explosive growth of information available on the web, users may experience a choice of countless products, movies, restaurants, etc. As such, personalization can be used for facilitating a better web experience for a user. Recommendation systems play a role in various information access systems and boost businesses by facilitating decision-making process, and recommendation systems are pervasive across numerous web domains such as e-commerce and/or media websites. Recommendation systems may generate recommendation lists based on user preferences, item features, past user-item interactions, and other information such as temporal and spatial data. Recommendation systems are mainly categorized into collaborative filtering, content-based recommendation systems, and hybrid recommendation systems based on the types of input data the recommendation systems receive.

Referring to FIG. 16B, an example in which a computing system (e.g., the computing system of FIG. 15) executes the recommendation system of FIG. 16A is illustrated.

A host device HD may execute a recommendation system RSYS, and may execute data and/or information related thereto. Each of a plurality of memory modules MM1, MM2, MM3 and MM4 may store at least one embedding table. For example, the memory module MM1 may store the embedding tables ET1 and ET2, the memory module MM2 may store the embedding tables ET3 and ET4, the memory module MM3 may store the embedding tables ET5 and ET6, and the memory module MM4 may store the embedding tables ET7 and ET8. For example, each embedding table may be assigned or allocated to one memory module.

In some implementations, when the plurality of memory modules MM1, MM2, MM3 and MM4 include processing units (e.g., the processing unit 350 in FIG. 3C), each of the plurality of memory modules MM1, MM2, MM3 and MM4 supports the execution of the recommendation system RSYS by performing computational operations using the stored embedding table and the processing unit. For example, when the memory modules MM1, MM2, MM3 and MM4 have the data processing function, the embedding tables ET1, ET2, ET3, ET4, ET5, ET6, ET7 and ET8 may be off-loaded to the memory modules MM1, MM2, MM3 and MM4.

Referring to FIG. 17A, an example of a graph neural network system 2300 executed by a computing system (e.g., the computing system of FIG. 15) is illustrated.

Various data and/or information may be used to execute the graph neural network system 2300. For example, to execute the graph neural network system 2300, various computational operations may be performed on the various data and/or information using an embedding vector (or embedding matrix) 2400. For example, the embedding vector 2400 may be divided into first to fourth sub-embedding vectors SEV1, SEV2, SEV3 and SEV4, but the division, number, and processing structure are not limited thereto.

Artificial neural networks (ANNs) are obtained by engineering a cell structure model of a human brain for efficiently performing pattern-recognition processes. An ANN may be a calculation model that is implemented through software or hardware and is designed to imitate biological calculation abilities by applying artificial neurons interconnected through connection lines. The human brain includes neurons that are basic units of a nerve, and encrypts or decrypts information according to different types of dense connections between these neurons. Artificial neurons in an ANN are obtained through simplification of biological neuron functionality. The term “deep learning” refers to the use of deep neural networks (DNNs), a type of ANN that include relatively complex layers and depths, to perform machine learning techniques. Both ANNs and DNNs perform a cognition or learning process by interconnecting artificial neurons of varying connection intensities. Thus, machine-learning processes and services may be performed based on one or more ANNs and DNNs. The past few decades have witnessed the tremendous success of deep-learning in many application domains, such as computer vision and speech recognition.

Graph neural networks (GNNs) belong to a class of artificial neural networks for processing data that may be represented as graphs. Certain existing neural network architectures may be interpreted as GNNs operating on suitably defined graphs. For example, a convolutional neural network (CNN) layer, in the context of computer vision, may be considered a GNN applied to graphs whose nodes are pixels and only adjacent pixels are connected by edges in the graph. For example, a transformer layer, in natural language processing, may be considered a GNN applied to complete graphs whose nodes are words or tokens in a passage of natural language text. Academia and industry have been in a race to apply GNNs to a wider range of domains due to its ability to solve many complex tasks while providing start-of-the-art results.

Referring to FIG. 17B, an example in which a computing system (e.g., the computing system of FIG. 15) executes the graph neural network system of FIG. 17A is illustrated.

A host device HD may execute a graph neural network system GSYS, and may execute data and/or information related thereto. Each of a plurality of memory modules MM1, MM2, MM3 and MM4 may store one sub-embedding vector. For example, the memory module MM1 may store the sub-embedding vector SEV1, the memory module MM2 may store the sub-embedding vector SEV2, the memory module MM3 may store the sub-embedding vector SEV3, and the memory module MM4 may store the sub-embedding vector SEV4. For example, the embedding vector may be divided into the sub-embedding vectors SEV1, SEV2, SEV3 and SEV4, and each sub-embedding vector may be assigned or allocated to one memory module.

In some implementations, when the plurality of memory modules MM1, MM2, MM3 and MM4 include processing units (e.g., the processing unit 350 in FIG. 3C), each of the plurality of memory modules MM1, MM2, MM3 and MM4 may support the execution of the graph neural network system GSYS by performing computational operations using the stored sub-embedding vector and the processing unit.

However, implementations are not limited thereto, and the memory modules included in the computing system may store various data and/or information and may perform various computational operations.

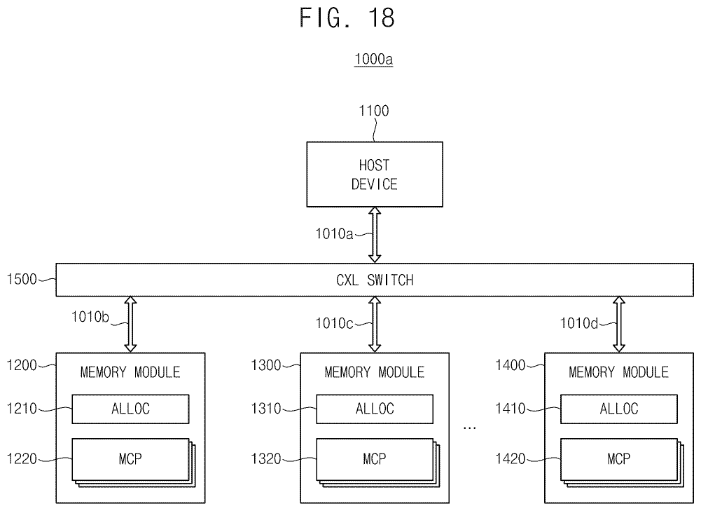

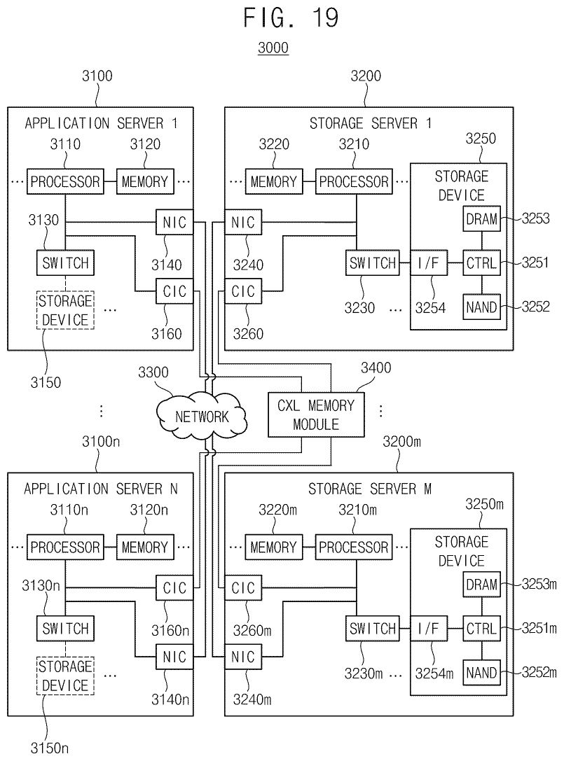

FIG. 18 is a block diagram illustrating a computing system according to some implementations of the present disclosure. The descriptions repeated with or overlapping with descriptions of FIG. 15 will be omitted in the interest of brevity.

Referring to FIG. 18, a computing system 1000a includes a host device 1100 and a plurality of memory modules 1200, 1300 and 1400. The computing system 1000a may further include buses 1010a, 1010b, 1010c and 1010d, and a CXL switch 1500.

The computing system 1000a may be substantially the same as the computing system 1000 of FIG. 15, except that the computing system 1000a includes the CXL switch 1500, and a configuration of the buses 1010a, 1010b, 1010c and 1010d is partially changed.

The CXL switch 1500 may connect the host device 1100 and the plurality of memory modules 1200, 1300 and 1400 with each other. For example, the CXL switch 1500 may be connected to the host device 1100 through the bus 1010a, and may be connected to the plurality of memory modules 1200, 1300 and 1400 through buses 1010b, 1010c and 1010d. The host device 1100 and the plurality of memory modules 1200, 1300 and 1400 may communicate with each other through the CXL switch 1500 and the buses 1010a, 1010b, 1010c and 1010d.

FIG. 19 is a block diagram illustrating an example of a data center including a memory module.

Referring to FIG. 19, a data center 3000 may be a facility that collects various types of data and provides various services, and may be referred to as a data storage center. The data center 3000 may be a system for operating search engines and databases, and/or may be a computing system used by companies such as banks or government agencies. The data center 3000 may include application servers 3100 to 3100n and storage servers 3200 to 3200m. The number of the application servers 3100 to 3100n and the number of the storage servers 3200 to 3200m may be variously selected, and the number of the application servers 3100 to 3100n and the number of the storage servers 3200 to 3200m may be—but need not be—different from each other.

The application server 3100 may include at least one processor 3110 and at least one memory 3120, and the storage server 3200 may include at least one processor 3210 and at least one memory 3220. An operation of the storage server 3200 will be described as an example. The processor 3210 may control overall operations of the storage server 3200, and may access the memory 3220 to execute instructions and/or data loaded in the memory 3220. The memory 3220 may include at least one of a double data rate (DDR) synchronous dynamic random access memory (SDRAM), a high bandwidth memory (HBM), a hybrid memory cube (HMC), a dual in-line memory module (DIMM), an Optane DIMM, a nonvolatile DIMM (NVDIMM), etc. The number of the processors 3210 and the number of the memories 3220 included in the storage server 3200 may be variously selected. In some implementations, the processor 3210 and the memory 3220 provide a processor-memory pair. In some implementations, the number of the processors 3210 and the number of the memories 3220 are different from each other. The processor 3210 may include a single core processor or a multiple core processor. The above description of the storage server 3200 may be similarly applied to the application server 3100. The application server 3100 may include at least one storage device 3150, and the storage server 3200 may include at least one storage device 3250. In some implementations, the application server 3100 do not include the storage device 3150. The number of the storage devices 3250 included in the storage server 3200 may be variously selected.

The application servers 3100 to 3100n and the storage servers 3200 to 3200m may communicate with each other through a network 3300. The network 3300 may be implemented using a fiber channel (FC) or an Ethernet. The FC may be a medium used for a relatively high speed data transmission, and an optical switch that provides high performance and/or high availability may be used. The storage servers 3200 to 3200m may be provided as file storages, block storages or object storages according to an access scheme of the network 3300.

In some implementations, the network 3300 may be a storage-only network or a network dedicated to a storage such as a storage area network (SAN). For example, the SAN may be an FC-SAN that uses an FC network and is implemented according to an FC protocol (FCP). As another example, the SAN may be an IP-SAN that uses a transmission control protocol/internet protocol (TCP/IP) network and is implemented according to an iSCSI (a SCSI over TCP/IP or an Internet SCSI) protocol. In some implementations, the network 3300 is a general network such as the TCP/IP network. For example, the network 3300 may be implemented according to at least one of protocols such as an FC over Ethernet (FCOE), a network attached storage (NAS), a nonvolatile memory express (NVMe) over Fabrics (NVMe-oF), etc.

Hereinafter, examples will be described based on the application server 3100 and the storage server 3200. The description of the application server 3100 may be applied to the other application server 3100n, and the description of the storage server 3200 may be applied to the other storage server 3200m.

The application server 3100 may store data requested to be stored by a user or a client into one of the storage servers 3200 to 3200m through the network 3300. In addition, the application server 3100 may obtain data requested to be read by the user or the client from one of the storage servers 3200 to 3200m through the network 3300. For example, the application server 3100 may be implemented as a web server or a database management system (DBMS).

The application server 3100 may access a memory 3120n or a storage device 3150n included in the other application server 3100n through the network 3300, and/or may access the memories 3220 to 3220m or the storage devices 3250 to 3250m included in the storage servers 3200 to 3200m through the network 3300. Thus, the application server 3100 may perform various operations on data stored in the application servers 3100 to 3100n and/or the storage servers 3200 to 3200m. For example, the application server 3100 may execute a command for moving or copying data between the application servers 3100 to 3100n and/or the storage servers 3200 to 3200m. The data may be transferred from the storage devices 3250 to 3250m of the storage servers 3200 to 3200m to the memories 3120 to 3120n of the application servers 3100 to 3100n directly or through the memories 3220 to 3220m of the storage servers 3200 to 3200m. For example, the data transferred through the network 3300 may be encrypted data for security or privacy.

In the storage server 3200, an interface 3254 of the storage device 3250 may provide a physical connection between the processor 3210 and a controller 3251 of the storage device 3250, and a physical connection between the controller 3251 and a network interface connector (NIC) 3240 and/or a CXL interface controller (CIC) 3260 of the storage device 3250. For example, the interface 3254 may be implemented based on a direct attached storage (DAS) scheme in which the storage device 3250 is directly connected with a dedicated cable. For example, the interface 3254 may be implemented based on at least one of various interface schemes such as an advanced technology attachment (ATA), a serial ATA (SATA) an external SATA (e-SATA), a small computer system interface (SCSI), a serial attached SCSI (SAS), a peripheral component interconnection (PCI), a PCI express (PCIe), an NVMe, a compute express link (CXL), an IEEE 1394, a universal serial bus (USB), a secure digital (SD) card interface, a multi-media card (MMC) interface, an embedded MMC (eMMC) interface, a universal flash storage (UFS) interface, an embedded UFS (eUFS) interface, a compact flash (CF) card interface, etc.

The storage server 3200 may further include a switch 3230, the NIC 3240 and the CIC 3260. The switch 3230 may selectively connect the processor 3210 with the storage device 3250 or may selectively connect the NIC 3240 and/or the CIC 3260 with the storage device 3250 under a control of the processor 3210. Similarly, the application server 3100 may further include a switch 3130, an NIC 3140 and a CIC 3160.

In some implementations, the NIC 3240 includes a network interface card, a network adapter, or the like. The NIC 3240 may be connected to the network 3300 through a wired interface, a wireless interface, a Bluetooth interface, an optical interface, or the like. The NIC 3240 may further include an internal memory, a digital signal processor (DSP), a host bus interface, or the like, and may be connected to the processor 3210 and/or the switch 3230 through the host bus interface. The host bus interface may be implemented as one of the above-described examples of the interface 3254. In some implementations, the NIC 3240 is integrated with at least one of the processor 3210, the switch 3230 and the storage device 3250.

In the storage servers 3200 to 3200m and/or the application servers 3100 to 3100n, the processor may transmit a command to the storage devices 3150 to 3150n and 3250 to 3250m or the memories 3120 to 3120n and 3220 to 3220m to program or read data. For example, the data may be error-corrected data by an error correction code (ECC) engine. For example, the data may be processed by a data bus inversion (DBI) or a data masking (DM), and may include a cyclic redundancy code (CRC) information. For example, the data may be encrypted data for security or privacy.

The storage devices 3150 to 3150m and 3250 to 3250m may transmit a control signal and command/address signals to NAND flash memory devices 3252 to 3252m of the storage devices 3250 and 3250m in response to a read command received from the processor. When data is read from the NAND flash memory devices 3252 to 3252m, a read enable (RE) signal may be input as a data output control signal and may serve to output data to a DQ bus. A data strobe signal (DQS) may be generated using the RE signal. The command and address signals may be latched in a page buffer based on a rising edge or a falling edge of a write enable (WE) signal.

The controller 3251 may control overall operations of the storage device 3250. In some implementations, the controller 3251 includes a static random access memory (SRAM). The controller 3251 may write data into the NAND flash memory device 3252 in response to a write command, or may read data from the NAND flash memory device 3252 in response to a read command. For example, the write command and/or the read command may be provided from the processor 3210 in the storage server 3200, the processor 3210m in the other storage server 3200m, or the processors 3110 to 3110n in the application servers 3100 to 3100n. A DRAM 3253 in the storage device 3250 may temporarily store (e.g., may buffer) data to be written to the NAND flash memory device 3252 or data read from the NAND flash memory device 3252. Further, the DRAM 3253 may store meta data. The meta data may be data generated by the controller 3251 to manage user data or the NAND flash memory device 3252.

The storage servers 3200 to 3200m and the application servers 3100 to 3100n may be connected to a CXL memory module 3400 through the CICs 3160 to 3160m and 3260 to 3260m and the CXL interface. The CXL memory module 3400 may be used as an expanded memory of each of the storage servers 3200 to 3200m and the application servers 3100 to 3100n. Each of the storage servers 3200 to 3200m and the application servers 3100 to 3100n may communicate with each other through the CXL interface and the CXL memory module 3400.

The CXL memory module 3400 may be a memory module as described with reference to FIGS. 1 through 12.

Various electronic devices and systems can include the disclosed memory modules. For example, the disclosed memory modules and computer systems can be included in systems such as a personal computer (PC), a server computer, a data center, a workstation, a mobile phone, a smart phone, a tablet computer, a laptop computer, a personal digital assistant (PDA), a portable multimedia player (PMP), a digital camera, a portable game console, a music player, a camcorder, a video player, a navigation device, a wearable device, an internet of things (IoT) device, an internet of everything (IoE) device, an e-book reader, a virtual reality (VR) device, an augmented reality (AR) device, a robotic device, a drone, an automotive vehicle, etc.

The foregoing is illustrative of examples. Although some examples have been described, those skilled in the art will readily appreciate that many modifications are possible without materially departing from the novel teachings and advantages of this disclosure. Accordingly, all such modifications are intended to be included within the scope of this disclosure.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. A memory module comprising:
a substrate;
an allocator on the substrate, the allocator being configured to communicate with an external device through a compute express link (CXL) interface;
a plurality of memory cluster packages on the substrate, the plurality of memory cluster packages being configured to be controlled by the allocator, wherein each of the plurality of memory cluster packages includes one or more memories and a memory controller, and wherein the plurality of memory cluster packages includes a first memory cluster package and a second memory cluster package; and
a plurality of serial communication lanes configured to transfer communications between the allocator and the plurality of memory cluster packages, wherein the plurality of serial communication lanes includes a first serial communication lane between the allocator and the first memory cluster package and a second serial communication lanes between the first memory cluster package and the second memory cluster package,
wherein the first memory cluster package is configured to communicate with the allocator through the first serial communication lane using a serial communication protocol, and
wherein the second memory cluster package is configured to communicate with the first memory cluster package through the second serial communication lane using the serial communication protocol.

2. The memory module of claim 1, wherein the first memory cluster package and the second memory cluster package are configured to communicate directly through the second serial communication lane over a communication path that bypasses the allocator.

3. The memory module of claim 2, wherein the second memory cluster package is configured to communicate with the allocator through the first serial communication lane and the second serial communication lane using the serial communication protocol.

4. The memory module of claim 2,
wherein the plurality of serial communication lanes include a third serial communication lane between the allocator and the second memory cluster package, and
wherein the second memory cluster package is configured to communicate with the allocator through the third serial communication lane using the serial communication protocol.

5. The memory module of claim 1, wherein the allocator includes:
a CXL communication circuit configured to support the CXL interface;
a cluster manager configured to control operations of the plurality of memory cluster packages; and
a plurality of serial communication circuits configured to support the serial communication protocol, the plurality of serial communication circuits including a first serial communication circuit,
wherein the first serial communication circuit is configured to be communicatively connected to the first memory cluster package through the first serial communication lane.

6. The memory module of claim 5,
wherein the plurality of serial communication circuits includes a second serial communication circuit,
wherein the plurality of serial communication lanes includes a third serial communication lane between the allocator and the second memory cluster package, and
wherein the second serial communication circuit is configured to be communicatively connected to the second memory cluster package through the third serial communication lane.

7. The memory module of claim 5, wherein at least one of the plurality of serial communication circuits, other than the first serial communication circuit, is configured to be disconnected from the plurality of serial communication lanes and the plurality of memory cluster packages.

8. The memory module of claim 1, wherein the first memory cluster package includes:
a first memory controller;
a plurality of first memories configured to be controlled by the first memory controller; and
a plurality of first serial communication circuits configured to support the serial communication protocol, the plurality of first serial communication circuits including a first-first serial communication circuit and a first-second serial communication circuit,
wherein the first-first serial communication circuit is configured to be communicatively connected to the allocator through the first serial communication lane, and
wherein the first-second serial communication circuit is configured to be communicatively connected to the second memory cluster package through the second serial communication lane.

9. The memory module of claim 8, wherein the first memory cluster package includes:
a first cluster controller configured to control communication with the second memory cluster package.

10. The memory module of claim 8, wherein the first memory cluster package includes:
a first processing unit (PU) configured to perform a computational operation on data stored in or read from the plurality of first memories.

11. The memory module of claim 8, wherein at least one of the plurality of first serial communication circuits, other than the first-first serial communication circuit and the first-second serial communication circuit, is configured to be disconnected from the plurality of serial communication lanes, the allocator, and memory cluster packages, other than the first memory cluster package, among the plurality of memory cluster packages.

12. The memory module of claim 8, wherein the second memory cluster package includes:
a second memory controller;
a plurality of second memories configured to be controlled by the second memory controller; and
a plurality of second serial communication circuits configured to support the serial communication protocol, the plurality of second serial communication circuits including a second-first serial communication circuit, and
wherein the second-first serial communication circuit is configured to be communicatively connected to the first memory cluster package through the second serial communication lane.

13. The memory module of claim 12,
wherein the plurality of second serial communication circuits includes a second-second serial communication circuit, and
wherein the plurality of serial communication lanes includes a third serial communication lane between the allocator and the second memory cluster package, and
wherein the second-second serial communication circuit is configured to be communicatively connected to the allocator through the third serial communication lane.

14. The memory module of claim 12, wherein at least one of the plurality of second serial communication circuits, other than the second-first serial communication circuit, is configured to be disconnected from the plurality of serial communication lanes, the allocator, and memory cluster packages, other than the second memory cluster package, among the plurality of memory cluster packages.

15. A computing system comprising:
a host device; and
a plurality of memory modules configured to communicate with the host device through a compute express link (CXL) interface,
wherein each of the plurality of memory modules includes:
a substrate;
an allocator on the substrate, the allocator being configured to communicate with the host device through the CXL interface;
a plurality of memory cluster packages on the substrate, the plurality of memory packages being configured to be controlled by the allocator, wherein each of the plurality of memory cluster packages includes one or more memories and a memory controller, and wherein the plurality of memory cluster packages includes a first memory cluster package and a second memory cluster package; and
a plurality of serial communication lanes configured to transfer communications between the allocator and the plurality of memory cluster packages, wherein the plurality of serial communication lanes includes a first serial communication lane between the allocator and the first memory cluster package and a second serial communication lane between the first memory cluster package and the second memory cluster package,
wherein the first memory cluster package is configured to communicate with the allocator through the first serial communication lane using a serial communication protocol, and
wherein the second memory cluster package is configured to communicate with the first memory cluster package through the second serial communication lane using the serial communication protocol.

16. The computing system of claim 15, wherein each of the plurality of memory cluster packages includes:
a processing unit (PU) configured to perform a computational operation on data stored in or read from the one or more memories of the memory cluster package.

17. The computing system of claim 16,
wherein the computing system is configured to execute a recommendation system, and
wherein each of the plurality of memory modules is configured to store at least one of a plurality of embedding tables used in the recommendation system, and configured to support the execution of the recommendation system by performing the computational operation using the processing unit and using the at least one embedding table stored in the memory module.

18. The computing system of claim 17,
wherein the computing system is configured to execute a graph neural network system,
wherein each of the plurality of memory modules is configured to store one of a plurality of sub-embedding vectors used in the graph neural network system, and configured to support the execution of the graph neural network system by performing the computational operation using the processing unit and using the sub-embedding vector stored in the memory module, and
wherein the plurality of sub-embedding vectors are divisions of an embedding vector used in the graph neural network system.

19. The computing system of claim 15, further comprising:
a CXL switch configured to connect the host device and the plurality of memory modules with one another.

20. A memory module comprising:
a substrate;
an allocator on the substrate, the allocator being configured to communicate with an external device through a compute express link (CXL) interface, wherein the allocator includes a first allocator-side serial communication circuit and a second allocator-side serial communication circuit;
a first memory cluster package on the substrate, the first memory cluster package being configured to be controlled by the allocator, wherein the first memory cluster package includes a first memory controller, one or more first memories, a first-first package-side serial communication circuit, and a first-second package-side serial communication circuit;
a second memory cluster package on the substrate, the second memory cluster package being configured to be controlled by the allocator, wherein the second memory cluster package includes a second memory controller, one or more second memories, a second-first package-side serial communication circuit, and a second-second package-side serial communication circuit; and
a first serial communication lane, a second serial communication lane, and a third serial communication lane configured to transfer communications between the allocator and the first and second memory cluster packages,
wherein the allocator and the first memory cluster package are configured to be communicatively connected to each other through the first allocator-side serial communication circuit, the first-first package-side serial communication circuit, and the first serial communication lane, to communicate with each other using a serial communication protocol,
wherein the first memory cluster package and the second memory cluster package are configured to be communicatively connected to each other through the first-second package-side serial communication circuit, the second-first package-side serial communication circuit, and the second serial communication lane, to communicate with each other using the serial communication protocol, and
wherein,
a) the allocator and the second memory cluster package are configured to be communicatively connected to each other through the second allocator-side serial communication circuit, the second-second package-side serial communication circuit, and the third serial communication lane, to communicate with each other using the serial communication protocol, or
b) the allocator and the second memory cluster package are configured to be communicatively connected to each other through the first allocator-side serial communication circuit, the first-first package-side serial communication circuit, the first serial communication lane, the first-second package-side serial communication circuit, the second-first package-side serial communication circuit, and the second serial communication lane, to communicate with each other using the serial communication protocol.
